(19) United States
(12) Patent Application Publication
(10) Pub. No.: US 2025/0157326 A1
(43) Pub. Date: May 15, 2025

(54) METHOD FOR UPLOADING VEHICLE DRIVING DATA AND ELECTRONIC DEVICE

(71) Applicant: HON HAI PRECISION INDUSTRY CO., LTD., New Taipei (TW)

(72) Inventors: Chih-Te LU, New Taipei (TW); Yu-Kai ZHOU, New Taipei (TW); Chin-Pin KUO, New Taipei (TW)

(21) Appl. No.: 18/599,689

(22) Filed: Mar. 8, 2024

(30) Foreign Application Priority Data
Nov. 14, 2023 (CN) 202311515284.3

(51) Int. Cl. G08G 1/01; G06N 3/044; G06N 3/0464; G08G 1/16

(52) U.S. Cl. CPC G08G 1/0129; G06N 3/044; G06N 3/0464; G08G 1/0112; G08G 1/16

(57) ABSTRACT

The present application provides a method for uploading vehicle driving data and an electronic device. The method includes: obtaining vehicle driving data of a target vehicle; predicting a vehicle accident occurrence probability of the target vehicle according to the vehicle driving data and a preset analysis model; when determining that the vehicle accident occurrence probability meets preset conditions, obtaining historical driving data of the target vehicle within a preset time period before a current time, and uploading the historical driving data to a cloud server. The above method can avoid a situation that the vehicle driving data for a period of time before the accident has not been uploaded, after the vehicle system fails due to a vehicle accident. By promptly uploading the historical driving data, therefore providing data support and improve accuracy for subsequent accident cause analysis.

This application claims priority to Chinese Patent Application No. 202311515284.3 filed on Nov. 14, 2023, in China National Intellectual Property Administration, the contents of which are incorporated by reference herein.

### FIELD

The subject matter herein generally relates to a vehicle technology field, in particular, relates to a method for uploading vehicle driving data and an electronic device.

### BACKGROUND

In recent years, with changes in lifestyle and a development of an automobile industry, more and more vehicles are on the road, and a vehicle accident occurrence probability has gradually increased. Vehicle driving data (for example, vehicle speed, video in the vehicle recorder, etc.) before and after one vehicle accident is an important basis for subsequent accident cause analysis, insurance claims and liability determination, and improvement of vehicle safety performance. However, in related vehicle systems, due to network and other reasons, when a vehicle system fails due to a vehicle accident, the vehicle driving data for a period of time before the accident has not been uploaded, thus affecting subsequent accident cause analysis, insurance claims and liability determination, accuracy of improving vehicle safety performance, etc.

### BRIEF DESCRIPTION OF THE DRAWINGS

In order to explain technical solutions of the embodiments of the present application more clearly, the drawings needed to be used in the description of the embodiments of the present application will be briefly introduced below. Obviously, the drawings in the following description are only some embodiments of the present application, for those of ordinary skill in the art, other drawings can also be obtained based on these drawings without exerting creative labor.

FIG. 1 shows an operating environment of a method for uploading vehicle driving data provided by the present application.

FIG. 2 is a flowchart of the method for uploading vehicle driving data provided by the present application.

FIG. 3 is a functional module diagram of a device for uploading vehicle driving data provided by the present application.

FIG. 4 is a structural diagram of an electronic device provided by the present application.

### DETAILED DESCRIPTION

It should be noted that the terms “first” and “second” in the description, claims and drawings of the application are used to distinguish similar objects, rather than describing a specific order or sequence.

In addition, it should be noted that the method disclosed in the embodiments of the present application or the method shown in the flowchart includes one or more steps for implementing the method. Without departing from the scope of the claims, the execution order of multiple steps may be interchanged with each other, and certain steps may also be deleted.

Some embodiments will be described below with reference to the accompanying drawings. The following embodiments and features in the embodiments may be combined with each other without conflict.

Please refer to FIG. 1, an operating environment of a method for uploading vehicle driving data provided by the present application is illustrated. As shown in FIG. 1, an electronic device 100 communicates with a cloud server 200. The electronic device 100 first obtains vehicle driving data of a target vehicle, and then predicts a vehicle accident occurrence probability of the target vehicle according to the vehicle driving data and a preset analysis model, and determines whether the vehicle accident occurrence probability of the target vehicle meets preset conditions, thereby determining whether the target vehicle is likely to be involved in an accident. If it is determined that the vehicle accident occurrence probability of the target vehicle meets the preset conditions, that is, it is determined that the target vehicle may be involved in an accident or encounter an accident, the electronic device 100 obtains historical driving data of the target vehicle within a preset time period at the current moment, and uploads the historical driving data to the cloud server 200 in a timely manner. The cloud server 200 receives the historical driving data and stores the historical driving data, or upload the historical driving data to a blockchain to avoid data loss or data tampering.

In some embodiments, when it is necessary to view the historical driving data for subsequent analysis of accident causes, insurance claims and liability determination, or improvement of vehicle safety performance, the user can remotely log in to the cloud server 200 to query the historical driving data. In one embodiment, the electronic device 100 connects to the cloud server 200 by an FTP/SFTP client tool, accesses the cloud server 200 by a file transfer way, and queries the historical driving data. In one embodiment, the electronic device accesses the cloud server 200 by corresponding application programming interface (API) or web console.

In some embodiments of the present application, a communication connection between the electronic device 100 and the cloud server 200 includes, but is not limited to, a wired communication connection or a wireless communication connection. The electronic device 100 may be any of a vehicle-mounted device, a control terminal, a server, and other devices. The cloud server 200 can provide cloud services, cloud databases, cloud computing, cloud functions, cloud storage, network services, cloud communications, middleware services, domain name services, security services, content delivery networks (CDNs), and basic cloud computing services such as big data and artificial intelligence platforms.

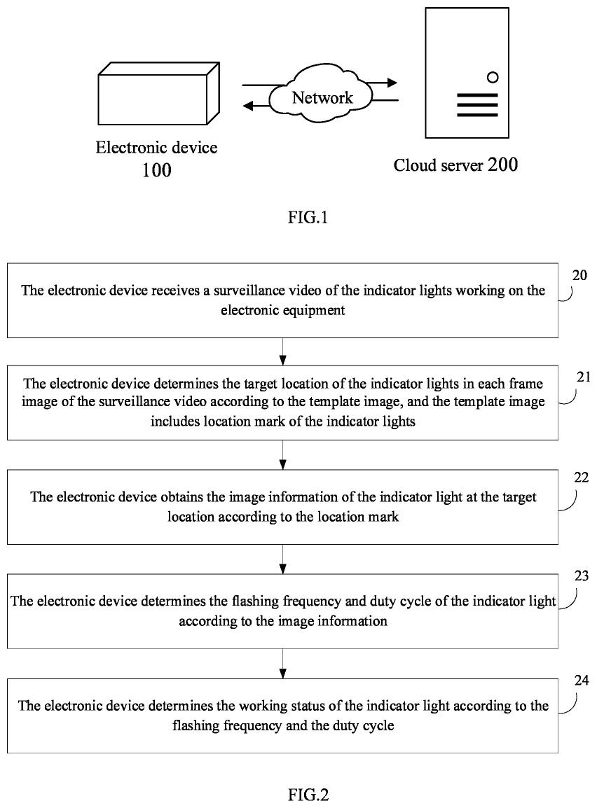

Please refer to FIG. 2, a flowchart of the method for uploading vehicle driving data provided by the present application is illustrated. The method is described using the electronic device 100 in FIG. 1 as an example, and includes the following steps.

At block S11, the vehicle driving data of the target vehicle is obtained.

In some embodiments, in order to more accurately predict the vehicle accident occurrence probability of the target vehicle, the vehicle driving data may include diverse driving data that may affect vehicle driving and may cause vehicle accidents. For example, the vehicle driving data includes a target vehicle's speed, acceleration, surrounding environment data (such as obstacles), vehicle driving position, etc.

In some embodiments, taking the electronic device as an on-board device in the target vehicle as an example, the target vehicle can collect a vehicle speed of the target vehicle by a vehicle speed sensor, collect a rotation angle and a rotation direction of a steering wheel when the target vehicle turns by a steering angle sensor, and collects an acceleration data by an acceleration sensor, obtain surrounding environment data when the vehicle is driving by a camera, and obtains vehicle positioning data by a Global Positioning System (GPS), etc. The target vehicle uses obtained vehicle speed, the rotation angle and rotation direction of the steering wheel when the target vehicle turns, the acceleration data, the surrounding environment data when the vehicle is driving, the vehicle positioning data, etc. as the vehicle driving data of the target vehicle.

In some embodiments of the present application, obtaining the vehicle driving data of the target vehicle, includes: detecting and recording the target vehicle's self-state data and environmental state data; and using the self-state data and the environmental state data as vehicle driving data.

In some embodiments, the electronic device can determine whether the target vehicle is involved an accident by detecting the environmental state data of the target vehicle, such as detecting a distance between the target vehicle and an obstacle. When the distance between the target vehicle and the obstacle is less than a certain distance (for example, when the distance between the target vehicle and the obstacle is less than or equal to 0), the electronic device determines that the target vehicle may be involved in the accident or has been involved in the accident. The electronic device also determines whether the target vehicle may be involved in the accident by detecting whether there are abnormal changes in the target vehicle's own state data. For example, the acceleration changes of the target vehicle can be detected. When the acceleration of the target vehicle changes significantly, it can be determined that the target vehicle may cause an accident. In order to improve a prediction accuracy of vehicle accidents, the electronic device obtains the target vehicle's own state data and the environmental state data as the vehicle driving data, and predicts the vehicle accident occurrence probability according to the vehicle driving data.

In some embodiments, the electronic device obtains the environmental state data around the target vehicle through the camera or other device of the target vehicle or by establishing a model, such as a distance analysis model. The electronic device obtains the target vehicle's own state data by detection devices (such as a sensor) of the target vehicle.

At block S12, the vehicle accident occurrence probability of the target vehicle is predicted according to the vehicle driving data and a preset analysis model.

In some embodiments, the preset analysis model includes but is not limited to a vehicle automatic braking assistance (AEB) system model and a vehicle blind spot detection (BSD) system model.

In some embodiments, the AEB system model can monitor obstacles around the vehicle by a microwave radar. When the microwave radar detects an obstacle and poses a collision risk to the vehicle, the AEB system model will provide an early warning to the driver and take corresponding braking measures. The BSD system model can monitor the blind spot by a radar. When the radar detects one vehicle approaching in the blind spot, the BSD system model will alert the driver and take corresponding braking measures. By the AEB system model and the BSD system model, the detection of obstacles or blind spots around the target vehicle can be realized, which can be used to predict the vehicle accident occurrence probability of the target vehicle.

In some embodiments, in order to improve the accuracy of predicting the vehicle accident occurrence probability, the electronic device predicts the vehicle accident occurrence probability of the target vehicle according to the vehicle driving data and the preset analysis model.

In some embodiments of the present application, predicting the vehicle accident occurrence probability of the target vehicle according to the vehicle driving data and the preset analysis model includes: using the preset analysis model to detect the driving state of the target vehicle to obtain the driving state data; predicts the vehicle accident occurrence probability according to the driving state data and the vehicle driving data.

In some embodiments, the electronic device may use a preset analysis model to detect the driving state of the target vehicle. For example, the electronic device uses the AEB system model and the BSD system model to detect whether there are obstacles within a certain distance from the target vehicle, and uses detection results as the driving state data of the target vehicle. The vehicle accident occurrence probability is predicted according to the driving state data and the vehicle driving data of the target vehicle.

In some embodiments, the electronic device can use the driving state data and the vehicle driving data as input data of a neural network model to predict the vehicle accident occurrence probability of the target vehicle. In some embodiments, the electronic device analyzes the driving state data and the vehicle driving data, and predicts the vehicle accident occurrence probability of the target vehicle by a regression analysis method, an average analysis method, a cross analysis method, a comprehensive evaluation analysis method and other analysis methods. The application does not limit the prediction method of the vehicle accident occurrence probability.

In one embodiment, predicting the vehicle accident occurrence probability of the target vehicle according to the vehicle driving data and a preset analysis model, includes: inputting the driving state data and the vehicle driving data into a preset neural network model; using the preset neural network model to encode the driving state data and the vehicle driving data, and obtaining a target feature vector; calculating a similarity value between the target feature vector and each of preset feature vectors; determining a preset probability of one preset feature vector corresponding to the similarity value greater than a preset threshold as the vehicle accident occurrence probability.

In some embodiments, when the neural network model is used to predict the vehicle accident occurrence probability according to the driving state data and the vehicle driving data of the target vehicle, the electronic device can obtain a large number of driving state data samples and the vehicle driving data samples in advance as training data, uses the training data to perform a unsupervised model training on the neural network model, and learn associations and potential rules between the training data in a training data set until the neural network model can be used to determine or identify the preset probability of the input training data, thus the preset neural network model is obtained. As an example, the preset probability can be a probability range, such as the probability range [0, 0.1), indicating that a vehicle accident will not occur; or the probability range [0.1, 0.8), indicating that the vehicle accident may occur; or the probability range [0.8, 1), indicating that the vehicle accident is about to occur; or a probability of 1, indicating that the vehicle accident is occurring.

In some embodiments, when the neural network model is used to predict the vehicle accident occurrence probability according to the driving state data and the vehicle driving data of the target vehicle, the electronic device can obtain multiple sets of driving state data samples and vehicle driving data samples in advance as the training data, and label each set of the training data with a corresponding vehicle accident occurrence probability. Then the electronic device uses labeled training data to perform a supervised model training to obtain the preset neural network model.

In some embodiments, the electronic device can also divide the labeled training data into a training data set and a test data set. After using the training data set to train the model, the test data set can be used to evaluate trained model and calculate an accuracy, a precision, a recall rate, etc. of the trained model, and optimizes the trained model according to the accuracy, the precision, or the recall rate, to obtain the preset neural network model.

In some embodiments, in a process of obtaining multiple sets of the driving state data samples and vehicle driving data samples as training data, and labeling each set of training data with corresponding vehicle accident occurrence probability, the electronic device can obtain a large number of the driving state data samples and vehicle driving data samples of accident-free vehicles and accident-related vehicles before and after the accident by crawler technology, and uses obtained data as the training data, and labels each set of the training data. For example, a corresponding vehicle accident occurrence probability of the training data occurring an accident can be marked as 1, and the corresponding vehicle accident occurrence probability of the training data occurring the accident for a preset time before and after the accident time can be marked as [0.8, 1), etc.

In some embodiments, in the process of using the preset neural network model to predict the vehicle accident occurrence probability of the target vehicle, the electronic device can use the target vehicle's driving state data and the vehicle driving data as the input data of the preset neural network model, and use the preset neural network model to encode the driving state data and the vehicle driving data to obtain the target feature vector, calculate the similarity values between the target feature vector and each of the preset feature vector, and determine the vehicle accident occurrence probability of the target vehicle based on the similarity values. In one embodiment, the preset probability of the preset feature vector corresponding to the similarity value greater than the preset threshold is used as the vehicle accident occurrence probability.

In some embodiments, the neural network model includes, but is not limited to, a recurrent neural network model and a convolutional neural network model.

In some embodiments of the present application, the electronic device can select data from the vehicle driving data and predict the vehicle accident occurrence probability according to the preset analysis model and selected data.

In some embodiments, if there are some data in the vehicle driving data that have little impact on the occurrence of vehicle accidents, the electronic device predicts the vehicle accident occurrence probability according to the preset analysis model and the vehicle driving data, which may affect a prediction accuracy of the vehicle accident occurrence probability. Based on the above faces, the electronic device selects some of the data that have a greater impact on the occurrence of vehicle accidents from the vehicle driving data, and predict the vehicle accident occurrence probability according to the preset analysis model and selected data to improve the prediction accuracy of the vehicle accident occurrence probability.

At block S13, when determining that the vehicle accident occurrence probability meets the preset conditions, historical driving data of the target vehicle within a preset time period before the current time is obtained, and the historical driving data is uploaded to the cloud server.

In some embodiments, the historical driving data of the target vehicle includes but is not limited to video data and vehicle driving data of the target vehicle within a preset period of time. The vehicle accident occurrence probability meeting the preset conditions includes, but is not limited to the vehicle accident occurrence probability being within the preset probability range or within the preset probability range. In one embodiment, the preset probability range can be customized. For example, the preset probability range can be set to [0.8, 1). In one embodiment, the preset probability range refers to the probability range corresponding to the scenarios where the vehicle may be involved in an accident, is about to suffer an accident, or has already occurred an accident.

In some embodiments, the current time refers to a time point when the electronic device determines that the vehicle accident occurrence probability meets the preset conditions. The preset time can be customized, for example, the preset time can be set to 5 minutes, 10 minutes, etc.

In some embodiments, when the electronic device determines that the vehicle accident occurrence probability meets the preset conditions, it may be determined that the vehicle may be involved in an accident, is about to be involved in an accident, or has already been involved in an accident. At this time, the electronic device can obtain the historical driving data of the target vehicle within the preset time period before the current time, and upload the historical driving data to the cloud server, therefore reducing a situation that the vehicle driving data for a period of time before the accident has not been uploaded, after the vehicle system fails due to a vehicle accident.

In some embodiments, the electronic device performs steps S11 to S13 in a loop, that is, when it is determined for the first time that the vehicle accident occurrence probability meets the preset conditions, the historical driving data of the target vehicle within the preset time period before the current time is obtained, and the historical driving data is uploaded to the cloud server. After the data is uploaded, the electronic device continues to obtain the vehicle driving data of the target vehicle, predicts the vehicle accident occurrence probability of the target vehicle. When determining that the vehicle accident occurrence probability meets the preset conditions, the electronic device obtains the historical driving data of the target vehicle within the preset time period before the current time, and uploads the historical driving data to the cloud server until a vehicle system of the target vehicle fails and the data cannot be uploaded.

In some embodiments, when determining that the vehicle accident occurrence probability meets the preset conditions, the electronic device obtains the driving data of the target vehicle within a certain period of time after the current time, and uploads the obtained driving data to the cloud server.

In some embodiments of the present application, uploading the historical driving data to the cloud server includes: obtaining a marking time of the historical driving data, and sorting sub-data in the historical driving data according to the marking time, and obtaining data upload sequence; uploading the historical driving data to the cloud server according to the data upload sequence and a preset priority.

In some embodiments, when obtaining the driving data of the target vehicle, the electronic device marks the time. Under normal circumstances, the driving data upload priority is arranged according to the marking time of the driving data, and the driving data is uploaded to the cloud server in sequence. For example, the electronic device can set the driving data with an earlier marking time and with a high priority, the higher the priority of the driving data, the higher the priority for uploading data.

In some embodiments, the preset priority may be the highest priority.

In some embodiments, when the vehicle accident occurrence probability meets the preset conditions, it is determined that the target vehicle may be involved in a vehicle accident or is currently involved in a vehicle accident. At this time, in order to avoid a loss of important driving data before and after the vehicle accident, and to completely save the important driving data before and after the vehicle accident, the electronic device can set the priority of the historical driving data of the target vehicle within the preset time period before the current time as the highest priority, and give priority to uploading the historical driving data. At the same time, since there may be sub-data in the historical driving data, the electronic device can sort the sub-data in the historical driving data according to the marking time corresponding to each sub-data to obtain the data upload sequence. For example, the marking times of sub-data in historical driving data are 9:00 am, 9:05 am, and 9:10 am. When the sub-data are sorted according to the order of marking time from early to late, the data upload sequence is the sub-data corresponding to the marking time marked as 9:00 am, the sub-data corresponding to the marking time marked as 9:05 am, and the sub-data corresponding to the marking time marked as 9:10 am. When the electronic device gives priority to uploading the historical driving data, the electronic device uploads the sub-data corresponding to 9:00 am, the sub-data corresponding to 9:05 am, and the sub-data corresponding to 9:10 am in sequence according to the data upload sequence.

In some embodiments of the present application, the electronic device can monitor a upload progress of the historical driving data. When the upload progress does not meet preset requirements, the upload speed of the historical driving data is adjusted.

In some embodiments, during the process of uploading the historical driving data to the cloud server, the electronic device can monitor the upload progress of the historical driving data in real time to ensure an integrity of the historical driving data and avoid data loss or slow upload progress leading to a network congestion or deadlock.

In some embodiments, the preset requirements include but are not limited to the upload progress being within a normal upload progress range. In one embodiment, the normal upload progress range can be customized. When the upload progress does not meet the preset requirements, the electronic device can determine that the upload progress of the historical driving data is abnormal. At this time, the electronic device can adjust the upload speed of the historical driving data so that the upload progress meets the normal upload progress range. For example, when determining that the upload progress of the historical driving data is too slow compared to the normal upload progress range, the electronic device can increase the upload speed of the historical driving data; when determining that the upload progress of the historical driving data is too fast compared to the normal upload progress range, the electronic device can reduce the upload speed of the historical driving data.

In the method for uploading vehicle driving data provided by an embodiment of the present application, the vehicle driving data of the target vehicle is obtained, and the vehicle accident occurrence probability of the target vehicle is predicted according to the vehicle driving data and the preset analysis model. Then, it is determined whether the vehicle accident occurrence probability of the target vehicle meets the preset conditions, and the preset condition can be set to a probability range corresponding to a situation where a vehicle accident may occur or vehicle accident has occurred. Therefore, when the vehicle accident occurrence probability of the target vehicle meets the preset conditions, it can be determined that the target vehicle may have an accident or is experiencing an accident. At this time, the electronic device can obtain the historical driving data of the target vehicle within the preset time period before the current moment, and upload the historical driving data to the cloud server in a timely manner. Therefore reducing a situation that the vehicle driving data for a period of time before the accident has not been uploaded, after the vehicle system fails due to a vehicle accident. By promptly uploading the historical driving data within a preset time period before the current time when it is predicted that the target vehicle may be involved in an accident or is experiencing an accident, therefore providing data support and improve accuracy for subsequent accident cause analysis, insurance claims and liability determination, improving vehicle safety performance, etc.

It should be understood that the sequence number of each step in the above embodiment does not mean execution orders. The execution orders of each step should be determined by its function and internal logic, and should not constitute any limitation on the implementation process of the embodiment of the present application.

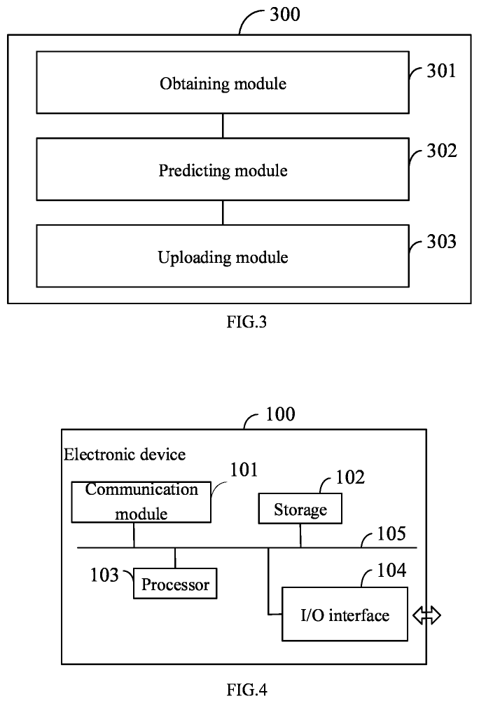

In one embodiment of the present application, a device 300 for uploading vehicle driving data is provided. The functions implemented by the device 300 correspond to the steps of the method for uploading vehicle driving data method in the above embodiments. As shown in FIG. 3, the device 300 includes an obtaining module 301, a predicting module 302 and an uploading module 303. The detailed description of each functional module is described as follows. The obtaining module 301 is used to obtain the vehicle driving data of the target vehicle. The predicting module 302 is used to predict the vehicle accident occurrence probability of the target vehicle according to the vehicle driving data and the preset analysis model. The uploading module 303 is used to obtain the historical driving data of the target vehicle within a preset time period before the current time is obtained, and uploads the historical driving data to the cloud server, when determining that the vehicle accident occurrence probability meets the preset conditions.

Regarding specific functions performed by the device 300, please refer to the limitations on the method for uploading vehicle driving data mentioned above, and will not be repeated here. Each module in the above-mentioned device 300 can be implemented in whole or in part by software, hardware, and combinations thereof. Each of the above modules can be embedded in or independent of the processor in the electronic device in the form of hardware, or can be stored in the memory of the electronic device in the form of software, so that the processor can call and execute the operations corresponding to each of the above modules.

Please refer to FIG. 4, a structural diagram of an electronic device provided by the present application is illustrated. The electronic device 100 includes but is not limited to any one of mobile phones, tablet computers, notebook computers, vehicle-mounted devices, smart wearable devices, and other devices. The network where the electronic device 100 is located includes but is not limited to the Internet, a wide area network, a metropolitan area network, a local area network, a virtual private network (VPN), etc.

As shown in FIG. 4, the electronic device 100 includes a communication module 101, a storage 102, a processor 103, an input/output (I/O) interface 104 and a bus 105. The processor 103 is coupled to the communication module 101, the storage 102, and the I/O interface 104 by the bus 105, respectively.

The communication module 101 may be a wireless communication module or a mobile communication module. The wireless communication module can provide applications on the electronic device 100 including wireless local area networks (WLAN) (such as wireless fidelity (Wi-Fi) network), Bluetooth (BT), and global navigation satellite systems. (GNSS), frequency modulation (FM), near field communication technology (NFC), infrared technology (IR) and other wireless communication solutions. The mobile communication module can provide wireless communication solutions including 2G/3G/4G/5G applied to the electronic device 100.

The storage 102 may include one or more random access memories (RAM) and one or more non-volatile memories (NVM). The random access memory can be directly read and written by the processor 103, can be used to store executable programs (such as machine instructions) of the operating system or other running programs, and can also be used to store user and application data, etc. The random access memory can include a static random-access memory (SRAM), a dynamic random access memory (DRAM), a synchronous dynamic random access memory (SDRAM), a double data rate synchronous dynamic random access memory (DDR SDRAM, for example, the fifth generation DDR SDRAM is generally called DDR5 SDRAM), etc.

The non-volatile memory can also store executable programs and user and application data, etc., and can be loaded into the random access memory in advance for direct reading and writing by the processor 103. The non-volatile memory can include disk storage devices and flash memory.

The storage 102 is used to store one or more computer programs. One or more computer programs are configured for execution by processor 103. The one or more computer programs include multiple instructions. When the multiple instructions are executed by the processor 103, the method for uploading vehicle driving data, executed on the electronic device 100 can be implemented.

In other embodiments, the electronic device 100 further includes an external memory interface for connecting to an external memory to expand the storage capacity of the electronic device 100.

The processor 103 may include one or more processing units. For example, the processor 103 may include an application processor (AP), a modem processor, a graphics processing unit (GPU), and an image signal processor (ISP), a controller, a video codec, a digital signal processor (DSP), a baseband processor, and/or neural network processor (NPU), etc. In one embodiment, different processing units can be independent devices or integrated into one or more processors.

The processor 103 provides computing and control capabilities. For example, the processor 103 is used to execute the computer program stored in the storage 102 to implement the above method for uploading vehicle driving data.

The I/O interface 104 is used to provide a channel for user input or output. For example, the I/O interface 104 can be used to connect various input and output devices, such as a mouse, a keyboard, a touch device, a display screen, etc., so that the user can input information. or obtain visualize information.

The bus 105 is at least used to provide a channel for mutual communication among the communication module 101, the storage 102, the processor 103, and the I/O interface 104 in the electronic device 100.

It can be understood that the structure illustrated in the embodiment of the present application does not constitute a specific limitation on the electronic device 100. In other embodiments of the present application, the electronic device 100 may include more or fewer components than shown in the FIG. 4, or some components may be combined, some components may be separated, or some components may be arranged differently. The components illustrated may be implemented in hardware, software, or a combination of software and hardware.

Embodiments of the present application also provide a computer-readable storage medium. A computer program is stored on the computer-readable storage medium. The computer program includes program instructions. The method implemented when the program instructions are executed may refer to the method for uploading vehicle driving data in the above-mentioned embodiments of the application.

In one embodiment, the computer-readable storage medium may be an internal memory of the electronic device described in the above embodiments, such as a hard disk or memory of the electronic device. The computer-readable storage medium may also be an external storage device of the electronic device, such as a plug-in hard disk, a smart memory card (SMC), or a secure digital (SD) card equipped on the electronic device), a Flash Card, etc.

Further, the computer-readable storage medium may mainly include a storage program area and a storage data area, wherein the storage program area may store an operating system, an application program required for at least one function, etc. The storage data area can store data created based on the use of electronic devices, etc.

The above description only represents some embodiments of the present application and is not intended to limit the present application, and various modifications and changes can be made to the present application. Any modifications, equivalent substitutions, improvements, etc. made within the spirit and scope of the present application are intended to be included within the scope of the present application.

What is claimed is:

1. A method for uploading vehicle driving data, the method comprising:
obtaining vehicle driving data of a target vehicle;
predicting a vehicle accident occurrence probability of the target vehicle according to the vehicle driving data and a preset analysis model;
in response that the vehicle accident occurrence probability meets preset conditions, obtaining historical driving data of the target vehicle within a preset time period before current time, and uploading the historical driving data to a cloud server.

2. The method as recited in claim 1, wherein predicting a vehicle accident occurrence probability of the target vehicle according to the vehicle driving data and a preset analysis model comprises:
detecting a driving state of the target vehicle by using the preset analysis model, and obtaining driving state data;
predicting the vehicle accident occurrence probability according to the driving state data and the vehicle driving data.

3. The method as recited in claim 2, wherein predicting the vehicle accident occurrence probability according to the driving state data and the vehicle driving data comprises:
inputting the driving state data and the vehicle driving data into a preset neural network model;
encoding the driving state data and the vehicle driving data by using the preset neural network model, and obtaining a target feature vector;
calculating a similarity value between the target feature vectors and each of preset feature vectors;
determining a preset probability of one preset feature vector corresponding to a similarity value that is greater than a preset threshold, as the vehicle accident occurrence probability.

4. The method as recited in claim 3, further comprising:
in response that the vehicle accident occurrence probability is within a preset probability range, determining that the vehicle accident occurrence probability meets the preset conditions.

5. The method as recited in claim 1, further comprising:
selecting data from the vehicle driving data;
predicting the vehicle accident occurrence probability according to the preset analysis model and selected data.

6. The method as recited in claim 1, wherein uploading the historical driving data to a cloud server comprises:
obtaining marking time of the historical driving data, and sorting sub-data in the historical driving data according to the marking time, and determining a data upload sequence;
uploading the historical driving data to the cloud server according to the data upload sequence and a preset priority.

7. The method as recited in claim 1, further comprising:
monitoring an upload progress of the historical driving data;
in responses that the upload progress does not meet preset requirements, adjusting an upload speed of the historical driving data.

8. The method as recited in claim 1, wherein obtaining vehicle driving data of a target vehicle comprises:
detecting and recording self-state data and environmental state data of the target vehicle;
using the self-state data and the environmental state data as the vehicle driving data.

9. An electronic device comprising:
a processor; and
a non-transitory storage medium, coupled to the processor, that stores a plurality of instructions, which cause the processor to:
obtain vehicle driving data of a target vehicle;
predict a vehicle accident occurrence probability of the target vehicle according to the vehicle driving data and a preset analysis model;
in response that the vehicle accident occurrence probability meets preset conditions, obtain historical driving data of the target vehicle within a preset time period before a current time, and upload the historical driving data to a cloud server.

10. The electronic device as recited in claim 9, wherein the plurality of instructions are further configured to cause the processor to:
detect a driving state of the target vehicle, and obtain driving state data by using the preset analysis model;
predicting the vehicle accident occurrence probability according to the driving state data and the vehicle driving data.

11. The electronic device as recited in claim 10, wherein the plurality of instructions are further configured to cause the processor to:
input the driving state data and the vehicle driving data into a preset neural network model;
encode the driving state data and the vehicle driving data, and obtain a target feature vector by using the preset neural network model;
calculate a similarity value between the target feature vectors and each of preset feature vectors;
determine a preset probability of one preset feature vector corresponding to the similarity value that is greater than a preset threshold as the vehicle accident occurrence probability.

12. The electronic device as recited in claim 11, wherein the plurality of instructions are further configured to cause the processor to:
in response that the vehicle accident occurrence probability is within a preset probability range, determine that the vehicle accident occurrence probability meets the preset conditions.

13. The electronic device as recited in claim 9, wherein the plurality of instructions are further configured to cause the processor to:
select data from the vehicle driving data;
predict the vehicle accident occurrence probability according to the preset analysis model and selected data.

14. The electronic device as recited in claim 9, wherein the plurality of instructions are further configured to cause the processor to:
obtain marking time of the historical driving data, and sort sub-data in the historical driving data according to the marking time, and determine a data upload sequence;
upload the historical driving data to the cloud server according to the data upload sequence and a preset priority.

15. The electronic device as recited in claim 9, wherein the plurality of instructions are further configured to cause the processor to:
monitor an upload progress of the historical driving data;
in responses that the upload progress does not meet preset requirements, adjust an upload speed of the historical driving data.

16. The electronic device as recited in claim 9, wherein the plurality of instructions are further configured to cause the processor to:
detect and record self-state data and environmental state data of the target vehicle;
use the self-state data and the environmental state data as the vehicle driving data.

17. A non-transitory storage medium having stored thereon instructions that, when executed by at least one processor of an electronic device, causes the at least one processor to perform a method for uploading vehicle driving data, the method comprising:
obtaining vehicle driving data of a target vehicle;
predicting a vehicle accident occurrence probability of the target vehicle according to the vehicle driving data and a preset analysis model;
in response that the vehicle accident occurrence probability meets preset conditions, obtaining historical driving data of the target vehicle within a preset time period before a current time, and uploading the historical driving data to a cloud server.

18. The non-transitory storage medium as recited in claim 17, wherein predicting a vehicle accident occurrence probability of the target vehicle according to the vehicle driving data and a preset analysis model comprises:
detecting a driving state of the target vehicle, and obtaining driving state data by using the preset analysis model;
predicting the vehicle accident occurrence probability according to the driving state data and the vehicle driving data.

19. The non-transitory storage medium as recited in claim 18, wherein predicting the vehicle accident occurrence probability according to the driving state data and the vehicle driving data comprises:
inputting the driving state data and the vehicle driving data into a preset neural network model;
encoding the driving state data and the vehicle driving data by using the preset neural network model, and obtaining a target feature vector;
calculating a similarity value between the target feature vectors and each of preset feature vectors;
determining a preset probability of one preset feature vector corresponding to the similarity value that is greater than a preset threshold as the vehicle accident occurrence probability.

20. The non-transitory storage medium as recited in claim 19, wherein the method further comprises:
in response that the vehicle accident occurrence probability is within a preset probability range, determining that the vehicle accident occurrence probability meets the preset conditions.
